(19) United States
(12) Patent Application Publication
(10) Pub. No.: US 2025/0164059 A1
(43) Pub. Date: May 22, 2025

(54) METHOD AND DEVICE FOR MOUNTING AND DETECTING A MARKER IN A SEWER OR PIPE SYSTEM

(71) Applicant: iPEK International GmbH, Sulzberg (DE)

(72) Inventors: Christian Schiebel, Marktoberdorf (DE); Hannes Endler, Marktoberdorf (DE)

(21) Appl. No.: 18/935,077

(22) Filed: Nov. 1, 2024

(30) Foreign Application Priority Data
Nov. 3, 2023 (DE) 10 2023 130 395.3

(51) Int. Cl. F16L 55/48; F16L 55/26; F16L 101/10; F16L 101/30; G01V 15/00

(52) U.S. Cl. CPC F16L 55/48; F16L 55/265; G01V 15/00; F16L 2101/10; F16L 2101/30

(57) ABSTRACT

A method for mounting a marker to a specific area in a pipeline and/or sewer system, wherein an inspection and/or maintenance system in the pipe-line and/or sewer system is brought into the region of the specific area, and the inspection and/or maintenance system mounts the marker to the specific area, wherein the marker comprises an RFID transponder, is provided. A method for detecting a marker in a pipeline and/or sewer system, a method for renovating a portion of a pipeline or sewer system, and devices for mounting the marker at the predetermined area in the sewer and for detecting the mounted marker are also provided.

### CROSS-REFERENCE TO RELATED APPLICATIONS

This application claims priority to German Patent Application Serial No. DE 10 2023 130 395.3, filed Nov. 3, 2023, the entire disclosure of which is hereby incorporated herein by reference in its entirety.

### FIELD OF THE INVENTION

The invention relates to a method for mounting a marker to a specific area in a pipeline and/or sewer system, and a method for detecting a marker in a pipeline and/or sewer system. In a further aspect, the invention relates to a method for renovating a portion of a pipeline and/or sewer system.

### BACKGROUND OF THE INVENTION

When renovating sewers, such as wastewater sewers, it is common practice to initially carry out an inspection of the sewer. Based on the results of the inspection, a renovation of the sewer is subsequently undertaken. During the renovation process, the area to be renovated is determined using a length measurement. For example, a milling device is moved forward in the sewer to an area to be milled free (e.g., in the region of a side inlet that is covered by a pipe liner), wherein the position of the area to be milled free can be specified as the distance to the sewer shaft (the distance can be ascertained within the framework of an inspection with the aid of a length measurement).

However, length measurement (both during inspection and during renovation) is time-consuming and can be subject to errors, which can lead to the milling process not being carried out at the desired area.

The relevant area (e.g., the side inlet covered by a pipe liner) can also be ascertained by means of sophisticated, highly sensitive radar technology. Here, an air pocket behind the pipe liner can be detected by evaluating the reflected radar waves. The pipe liner can then be removed at this area. However, the use of radar technology is not always reliable, since it can also misinterpret voids (cavities between the pipe liner and the sewer wall) as side inlets. Thus, this measuring method is not suitable for being able to carry out automated milling.

### OBJECT OF THE INVENTION

It is therefore the object of the present invention to provide solutions with which a simple and reliable localization of predetermined areas (e.g., an area to be milled free) in the sewer is made possible, in order in turn to ensure a proper renovation of the sewer.

### SUMMARY OF THE INVENTION

This task is achieved with the methods and devices according to the independent claims. Advantageous embodiments of the invention are set forth in the specific dependent claims.

Accordingly, a method is provided for mounting a marker to a specific area in a pipeline and/or sewer system, wherein
an inspection and/or maintenance system in the pipeline and/or sewer system is brought into the region of the specific area,
the inspection and/or maintenance system mounts the marker to the specific area, wherein the marker comprises an RFID transponder.

It is advantageous if the mounting of the marker is selected from the group comprising
mounting of the marker to an inner wall of the pipeline and/or sewer system or to an object arranged in the pipeline and/or sewer system (e.g., a sleeve),
insertion of the marker into a recess made or existing on the inner wall of the pipeline and/or sewer system, and
clamping of the marker using clamping means in the pipeline and/or sewer system, in particular in a side inlet of the pipeline and/or sewer system.

Before, during or after the mounting of the RFID transponder, data can be written to it, preferably by means of an RFID writing device arranged on the inspection and/or maintenance system.

The data can be selected from the group comprising
an identifier, in particular a unique identifier, for identifying the RFID transponder,
the position of a side inlet of the pipeline and/or sewer system,
an identifier and/or the position of the specific area (e.g., the identifier of an object in the sewer and its position in the sewer),
the angle of a side inlet of the pipeline and/or sewer system,
the diameter of a side inlet of the pipeline and/or sewer system,
the diameter of the pipeline and/or sewer system,
the position of the RFID transponder relative to the center point of a side inlet of the pipeline and/or sewer system,
the distance to the starting point of a pipe within the pipeline and/or sewer system,
the geometry of the side inlet of the pipeline and/or sewer system, and
combinations thereof.

A method for detecting a marker in a pipeline and/or sewer system is further provided, wherein the marker is mounted at a specific area in the pipeline and/or sewer system, wherein the marker comprises an RFID transponder, wherein
an inspection and/or maintenance system, which has an RFID reader, is moved or advanced in the pipeline and/or sewer system until the RFID reader detects the RFID transponder,
the RFID reader or a data processing device coupled to the RFID reader ascertains the position of the RFID transponder relative to the RFID reader, and
the ascertained position of the RFID transponder relative to the RFID reader is used to ascertain the specific area at which the marker is mounted.

It can be advantageous if data stored in the RFID transponder are read (by means of the RFID reader).

The ascertained position of the RFID transponder can correspond to a position of a side inlet of the pipeline and/or sewer system or a position of an object in the pipeline and/or sewer system. Alternatively, based on the data and the ascertained position of the RFID transponder, a position of a side inlet of the pipeline and/or sewer system or a position of an object in the pipeline and/or sewer system can be ascertained.

A method for renovating a portion of a pipeline or sewer system is also provided, wherein a side inlet extends from the portion, wherein
a marker is mounted in the region of the side inlet or in the side inlet, preferably using an inspection and/or maintenance system, wherein the marker comprises an RFID transponder,
wherein a pipe liner is inserted in the portion, wherein the pipe liner at least partially covers or conceals the side inlet,
the mounted RFID transponder is detected with an RFID reader, which is preferably arranged on an inspection and/or maintenance system,
the position of the RFID transponder relative to the RFID reader is ascertained, wherein
the ascertained position of the RFID transponder corresponds to the position of a side inlet of the pipeline and/or sewer system, or
data are read from the RFID transponder and a position of the side inlet of the pipeline and/or sewer system is ascertained based on the data and the ascertained position of the RFID transponder, and
at the position of the side inlet, the pipe liner is removed, preferably using a milling device of the inspection and/or maintenance system, in order to expose the side inlet.

The mounting of the marker can be selected from the group comprising
mounting of the marker to an inner wall of the pipeline and/or sewer system,
insertion of the marker into a recess made or existing on the inner wall of the pipeline and/or sewer system, and
clamping of the marker using clamping means in the pipeline and/or sewer system, in particular in a side inlet of the pipeline and/or sewer system.

Here, the data can comprise
an identifier, in particular a unique identifier,
the position of a side inlet of the pipeline and/or sewer system,
the angle of a side inlet of the pipeline and/or sewer system,
the diameter of a side inlet of the pipeline and/or sewer system,
the diameter of the pipeline and/or sewer system,
the position of the RFID transponder relative to the center point of a side inlet of the pipeline and/or sewer system,
the distance to the starting point of a pipe within the pipeline and/or sewer system,
the geometry of the side inlet of the pipeline and/or sewer system, and
combinations thereof.

A device comprising a carriage of a sewer inspection and/or maintenance system, on which an arm is arranged, which is movable with a plurality of degrees of freedom relative to the carriage, is also provided, wherein
at a free end of the arm, receiving means are provided for receiving a marker, in particular an RFID transponder,
the arm is configured to move the receiving means with the marker received thereby to a predetermined area in a pipeline and/or sewer system, and
the receiving means are configured to mount the marker at the predetermined area.

A magazine for receiving a number of markers can be provided on the carriage, wherein the arm is further configured to move the receiving means to the magazine and wherein the receiving means are further configured to receive a marker from the magazine.

An RFID writing device can be arranged on the carriage and/or on the arm and/or on the receiving means, which RFID writing device is adapted to write data to the RFID transponder before, during or after it is mounted.

Finally, a device comprising a carriage of a sewer inspection and/or maintenance system and an RFID reader is provided.

The RFID reader can be adapted to detect an RFID transponder mounted in the sewer. The RFID reader can be arranged on the carriage.

### BRIEF DESCRIPTION OF THE DRAWINGS

Further details and features of the invention as well as specific, in particular advantageous exemplary embodiments of the invention become apparent from the following description in conjunction with the drawing. In the figures:

FIG. 1 shows an example of a device (carriage) in a sewer, with which a marker can be mounted in the sewer; and

FIG. 2 shows an example of a device (carriage) in a sewer, with which a marker can be detected in the sewer.

### DETAILED DESCRIPTION OF THE INVENTION

The invention makes it possible to reliably and accurately locate predetermined areas (e.g., an area to be milled free or an object in the sewer, such as a sleeve) in the sewer.

Here, markers, such as RFID markers or RFID transponders, are mounted to specific areas in the sewer, for example during a sewer inspection. The markers can be recognized automatically and error-free by a milling robot, for example. If the pipe to be renovated is covered with a pipe liner, the areas to be milled free can be detected easily and, above all, error-free.

The marker can be placed at the area itself or at a position relative to it. Adhesive techniques can be used to place the marker, the marker can be inserted into the pipe wall in a drilled/milled area or recess, or the marker can be braced in the side inlet using support components. During or after placement, additional data can be written to the marker or RFID transponder, in particular if the marker is placed relative to the actual area.

A carriage or sliding system with an RFID reader can ascertain the position of the RFID transponder relative to the RFID reader by means of measured values, such as RSSI (Received Signal Strength. Indicator), with millimeter precision. Additional data stored in the RFID transponder can be read and used, for example, as information for a subsequent milling process.

The method also has the advantage that the RFID transponder can be detected even if it is covered by a pipe liner, for example.

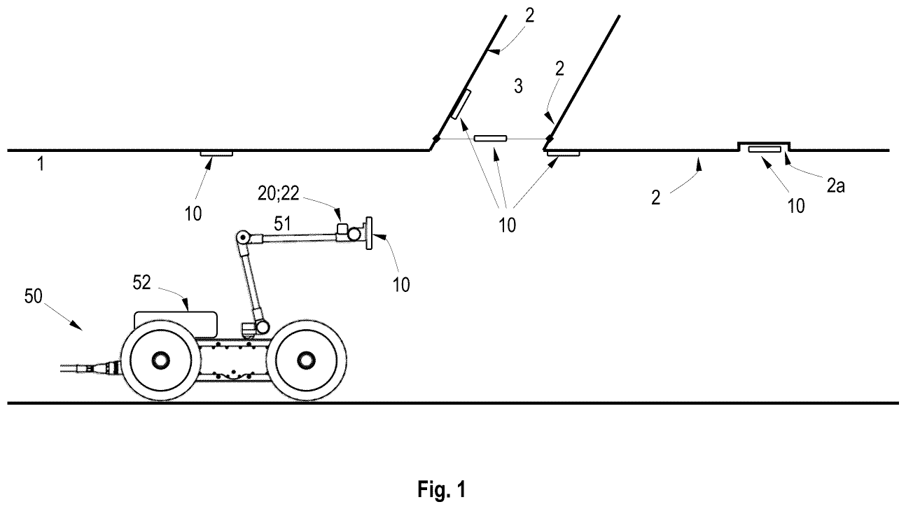

FIG. 1 shows a carriage 50 in a sewer 1, with which markers 10 are mounted in the sewer. In this example, the markers are RFID transponders.

The carriage 50 has an arm 51, which can be moved relative to the carriage 50 with a plurality of degrees of freedom. The free end of the arm 51 is provided with receiving means for receiving an RFID transponder 10. The receiving means can be a type of gripper with which the RFID transponder 10 can be held.

A magazine 52, in which a number of RFID transponders are housed, is arranged on the carriage. The arm 51 is preferably configured so that it can move the receiving means to the magazine in order to remove an RFID transponder from the magazine with the receiving means. The magazine is optional, so that according to the invention only a single RFID transponder can be brought into the sewer with the carriage and mounted there.

The arm 51 is also configured to move the receiving means with the RFID transponder 10 received by it to a predetermined area in the sewer 1 and to mount it to the predetermined area in the sewer.

FIG. 1 shows a plurality of RFID transponders 10 already mounted in the sewer. Two RFID transponders 10 have been mounted to the inner sewer wall, for example by means of an adhesive fastened to the inner sewer wall 2. A further RFID transponder 10 has been inserted into a recess 2a in the inner sewer wall 2—here as well, an adhesive can be used for fastening the RFID transponder 10 in the recess 2a. A further RFID transponder 10 has been fastened to the wall 2 of a side inlet 3. Yet a further RFID transponder 10 has been fastened to the side inlet 3 using clamping means. Other suitable systems can also be used for fastening the RFID transponder 10 to a predetermined area in the sewer, e.g. magnetic fastening, press-fitting or the like.

In the case of plastic pipes or a sewer made of plastic pipes, a transponder holder on which the RFID transponder is arranged can be heated and the heated transponder holder can be fused to the inner wall of the pipe.

Other suitable methods of fastening are also possible, as long as the RFID transponders are mounted to an inner wall 2 of the pipeline and/or sewer system in such a way that they remain there at least temporarily. Here, “remain there temporarily” means that the RFID transponders remain there at least until the purpose of the marker has been fulfilled (e.g., until a sewer renovation system has detected the RFID transponder). Once the purpose has been fulfilled, the RFID transponders can remain in the sewer or be removed again.

Although FIG. 1 shows a plurality of RFID transponders 10 mounted in the sewer, one RFID transponder 10 is usually sufficient for marking an area to be processed in the sewer, for example.

However, a plurality of RFID transponders 10 per area to be processed can increase accuracy or be advantageous for redundancy purposes. For example, a specific area in the sewer can be ascertained from a plurality of RFID transponders placed at a distance from one another by means of triangulation.

Before, during or after the mounting of an RFID transponder 10, data can be written to it, preferably by means of an RFID writing device 22, which is arranged here at the front end of the arm 51.

The following data or types of data have proved to be advantageous here, although the invention is not limited to these data or types of data:
an identifier, in particular a unique identifier,
the position of a side inlet of the pipeline and/or sewer system,
the angle of a side inlet of the pipeline and/or sewer system,
the diameter of a side inlet of the pipeline and/or sewer system (1),
the diameter of the pipeline and/or sewer system,
the position of the RFID transponder relative to the center point of a side inlet of the pipeline and/or sewer system,
the distance to the starting point of a pipe within the pipeline and/or sewer system,
an identifier and/or the position of the specific area (for example, an identifier of an object (such as a sleeve) and a position of the object in the sewer can be stored),
the geometry of the side inlet of the pipeline and/or sewer system, and
combinations thereof.

For example, an RFID transponder 10 can be placed next to a side inlet 3. If the position of the RFID transponder relative to the center point of a side inlet and the diameter of the side inlet are stored as data in this RFID transponder, based on this data, a milling system can, for example, mill out a pipe liner exactly at this area (center point) and in the proper size.

It is also possible, for example, to place the RFID transponder 10 opposite the area to be processed or the side inlet in the sewer. The position of a side inlet stored in the RFID transponder 10 can still be used to properly ascertain the area to be milled free.

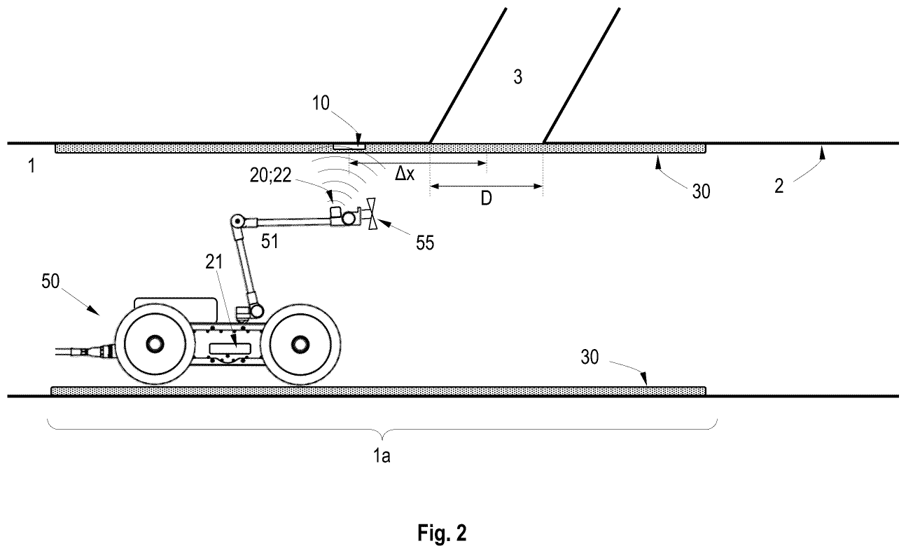

FIG. 2 shows a carriage (designed as a milling device), with which a marker in the sewer can be detected, in a sewer.

A side inlet 3 branches off from the sewer.

In a previous inspection process, an RFID transponder 10 was mounted to the inner sewer wall 2 in the region near the side inlet 3 (as described with reference to FIG. 1). The position (as distance Δx) of the RFID transponder relative to the center point of the side inlet 3 and the diameter D of the side inlet 3 were stored as data in the RFID transponder 10 using an RFID writing device.

In a subsequent renovation process, a pipe liner 30 was inserted into region 1a of the sewer, covering the side inlet 3. The pipe liner also covers the RFID transponder 10.

With the carriage 50 shown in FIG. 2, which is configured as a milling device, the pipe liner in the region of the side inlet is to be removed again in order to restore the function of the side inlet.

The carriage 50 has an arm 51, which can be moved relative to the carriage 50 with a plurality of degrees of freedom. A milling device 55 is arranged at the free end of the arm 51, with which the side inlet is to be opened or the pipe liner in the region of the side inlet is to be removed.

An RFID reader 20 is arranged at the front end of the arm 51. On the one hand, the RFID reader detects the RFID transponder 10 (once it is within range of the RFID reader). On the other hand, the data stored in the RFID transponder are read, in this example it is the position (as distance Δx) of the RFID transponder 10 relative to the center point of the side inlet 3 and the diameter D of the side inlet 3.

When detecting the RFID transponder 10, the position of the RFID transponder 10 relative to the RFID reader 20 is ascertained by means of measured values, such as RSSI (Received Signal Strength Indicator), with millimeter precision.

With
the position of the RFID transponder 10 relative to the RFID reader 20,
the position (as distance Δx) of the RFID transponder 10 relative to the center point of the side inlet 3 and
the diameter D of the side inlet 3,
   the position of the side inlet relative to the carriage 50 (or relative to the milling device 55) and the diameter of the side inlet are known, so that a precise opening of the side inlet is ensured.

Based on this information, the arm 51 and the milling device 55 can be controlled so that the milling device 55 removes the pipe liner precisely in the region of the side inlet 3.

The RFID reader 20 can be coupled to a data processing device 21 of the carriage, which, based on this information, takes over control of the arm 51 and the milling unit 55. Optionally, the data processing device 21 can also take over the control of the carriage 50, for example if the carriage still needs to be moved so that the milling device 55 can reach the area to be milled.

As a result, not only safe and precise removal of the pipe liner in the region of the side inlet is made possible. After detecting the RFID transponder 10 and reading the data from the RFID transponder, the carriage 50, which is configured as a milling device, can open the side inlet completely autonomously, i.e. without human intervention.

The mounting of an RFID transponder in the sewer and the detection of a mounted RFID transponder for the purpose of sewer renovation with a pipe liner, which has to be partially removed again, was described above.

According to the invention, RFID transponders can also be mounted in the sewer and subsequently detected for other purposes. For example, during a sewer inspection, RFID transponders can be mounted to predetermined areas in the sewer that need to be found again at a later point in time, such as when measurements have to be carried out with different inspection systems and the measurements require a common, unique reference point to which the different inspection systems can align themselves.

We claim:

1. A method for mounting a marker to a specific area in a pipeline and/or sewer system, wherein
an inspection and/or maintenance system in the pipeline and/or sewer system is brought into the region of the specific area,
the inspection and/or maintenance system mounts the marker to the specific area, wherein the marker comprises an RFID transponder.

2. The method according to claim 1, wherein the mounting of the marker is selected from a group consisting of:
mounting of the marker to an inner wall of the pipeline and/or sewer system,
insertion of the marker into a recess made or existing on the inner wall of the pipeline and/or sewer system, and
clamping of the marker using clamping means in the pipeline and/or sewer system, in particular in a side inlet of the pipeline and/or sewer system.

3. The method according to claim 1, wherein before, during or after the mounting of the RFID transponder, data is written to the RFID transponder.

4. The method according to claim 3, wherein the data is selected from a group consisting of:
an identifier, in particular a unique identifier, for identifying the RFID transponder,
a position of a side inlet of the pipeline and/or sewer system,
an identifier and/or the position of the specific area,
an angle of a side inlet of the pipeline and/or sewer system,
a diameter of a side inlet of the pipeline and/or sewer system,
a diameter of the pipeline and/or sewer system,
a position of the RFID transponder relative to the center point of a side inlet of the pipeline and/or sewer system,
a distance to the starting point of a pipe within the sewer system,
a geometry of the side inlet of the pipeline and/or sewer system, and
combinations thereof.

5. A method for detecting a marker in a pipeline and/or sewer system, wherein the marker is mounted at a specific area in the pipeline and/or sewer system, wherein the marker comprises an RFID transponder, wherein
an inspection and/or maintenance system, which has an RFID reader, is moved or advanced in the pipeline and/or sewer system until the RFID reader detects the RFID transponder,
the RFID reader or a data processing device coupled to the RFID reader ascertains the position of the RFID transponder relative to the RFID reader, and
the ascertained position of the RFID transponder relative to the RFID reader is used to ascertain the specific area at which the marker is mounted.

6. The method according to claim 5, wherein data stored in the RFID transponder is read.

7. The method according to claim 6, wherein the ascertained position of the RFID transponder corresponds to a position of a side inlet of the pipeline and/or sewer system or a position of an object in the pipeline and/or sewer system, or wherein a position of a side inlet of the pipeline and/or sewer system or a position of an object in the pipeline and/or sewer system is ascertained based on the data and the ascertained position of the RFID transponder.

8. A method for renovating a portion of a pipeline or sewer system, wherein a side inlet extends from the portion, wherein
a marker is mounted in the region of the side inlet or in the side inlet, wherein the marker comprises an RFID transponder,
wherein a pipe liner is inserted in the portion, wherein the pipe liner at least partially covers or conceals the side inlet,
the mounted RFID transponder is detected with an RFID reader,
the position of the RFID transponder relative to the RFID reader is ascertained, wherein
the ascertained position of the RFID transponder corresponds to the position of a side inlet of the pipeline and/or sewer system, or
data are read from the RFID transponder and a position of the side inlet of the pipeline and/or sewer system is ascertained based on the data and the ascertained position of the RFID transponder, and
at the position of the side inlet, the pipe liner is removed, in order to expose the side inlet.

9. The method according to claim 8, wherein the mounting of the marker step is selected from a group consisting of:
mounting of the marker to an inner wall of the pipeline and/or sewer system,
insertion of the marker into a recess made or existing on the inner wall of the pipeline and/or sewer system, and
clamping of the marker using clamping means in the pipeline and/or sewer system, in particular in a side inlet of the pipeline and/or sewer system.

10. The method according to claim 8, wherein the data comprise
an identifier, in particular a unique identifier,
a position of a side inlet of the pipeline and/or sewer system,
an angle of a side inlet of the pipeline and/or sewer system,
a diameter of a side inlet of the pipeline and/or sewer system,
a diameter of the pipeline and/or sewer system,
a position of the RFID transponder relative to the center point of a side inlet of the pipeline and/or sewer system,
a distance to the starting point of a pipe within the sewer system,
a geometry of the side inlet of the pipeline and/or sewer system, and
combinations thereof.

11. A device comprising a carriage of a sewer inspection and/or maintenance system, on which an arm is arranged, which is movable with a plurality of degrees of freedom relative to the carriage, wherein
at a free end of the arm, receiving means is provided for receiving a marker, in particular an RFID transponder,
the arm is configured to move the receiving means with the marker received thereby to a predetermined area in a pipeline and/or sewer system, and
the receiving means is configured to mount the marker at the predetermined area.

12. The device according to claim 11, wherein a magazine for receiving a number of markers is provided on the carriage, wherein the arm is further configured to move the receiving means to the magazine and wherein the receiving means is further configured to receive a marker from the magazine.

13. The device according to claim 11, wherein an RFID writing device is arranged on the carriage and/or on the arm and/or on the receiving means, which is adapted to write data to the RFID transponder before, during or after it is mounted.

14. A device comprising a carriage of a sewer inspection and/or maintenance system and an RFID reader.

15. The device according to claim 14, wherein the RFID reader is adapted to detect an RFID transponder mounted in the sewer.

16. The method according to claim 3, wherein the data is written to the RFID transponder by means of an RFID writing device arranged on the inspection and/or maintenance system.

17. The method according to claim 8, wherein:
the RFID reader is preferably arranged on an inspection and/or maintenance system, and
the step of removing the pipe liner is completed using a milling device of the inspection and/or maintenance system.
